(19) United States
(12) Patent Application Publication
(10) Pub. No.: US 2020/0098329 A1
(43) Pub. Date: Mar. 26, 2020

(54) DISPLAY DRIVER, ELECTRONIC APPARATUS, AND MOBILE BODY

(71) Applicant: SEIKO EPSON CORPORATION, Tokyo (JP)

(72) Inventor: Hironori KOBAYASHI, Chino-shi (JP)

(73) Assignee: SEIKO EPSON CORPORATION, Tokyo (JP)

(21) Appl. No.: 16/577,339

(22) Filed: Sep. 20, 2019

(30) Foreign Application Priority Data
Sep. 21, 2018 (JP) 2018-177073

(51) Int. Cl. G09G 3/36; G09G 3/3225

(52) U.S. Cl. CPC G09G 3/3696; G09G 2330/021; G09G 3/3225; G09G 3/3648

(57) ABSTRACT

A display driver includes a power supply circuit that generates a power supply voltage, a drive circuit that drives an electro-optical panel based on the power supply voltage, a control circuit that controls the drive circuit, a power supply line through which the power supply voltage from the power supply circuit is supplied to the drive circuit, a first monitoring circuit that monitors the voltage at a first node, of the power supply line, that is closer to the power supply circuit than to the drive circuit, and outputs the monitoring result to the control circuit, and a second monitoring circuit that monitors the voltage at a second node, of the power supply line, that is closer to the drive circuit than to the power supply circuit, and outputs the monitoring result to the control circuit.

The present application is based on, and claims priority from JP Application Serial Number 2018-177073, filed Sep. 21, 2018, the disclosure of which is hereby incorporated by reference herein in its entirety.

### BACKGROUND

### 1. Technical Field

The present disclosure relates to a display driver, an electronic apparatus, a mobile body, and the like.

### 2. Related Art

In a display driver of an electro-optical panel, various power supply voltages are used in drive circuits that drive an electro-optical panel. These power supply voltages are generated by a power supply circuit and are supplied to the drive circuits. Because the drive circuits drive the electro-optical panel using the supplied power supply voltages, if an anomaly occurs in the power supply voltages, the electro-optical panel cannot be properly driven, and a problem such as anomalous display occurs.

A technology disclosed in JP-A-2001-249317 is a known technology for detecting such an anomaly in the power supply voltages, for example. In the display drive device disclosed in JP-A-2001-249317, a charge pump circuit generates a power supply voltage VGL and the like and supplies these voltages to a scan driver. The power supply voltage VGL generated by the charge pump circuit is also supplied to a voltage detection circuit, and its voltage value is detected. Also, the scan driver and a signal driver are set to a stand-by state until the power supply voltage VGL reaches a predetermined voltage value. As a result of setting the scan driver and the signal driver to a stand-by state, a liquid-crystal display panel, which is an electro-optical panel, enters a state in which its display is turned off. With this, anomalous display of a liquid-crystal display panel caused by the power supply voltage VGL not having reached a predetermined voltage value can be prevented.

In the display drive device disclosed in JP-A-2001-249317, the voltage detection circuit is provided in the charge pump circuit, which is a power supply circuit, and the voltage of the power supply voltage VGL is detected. Therefore, an anomaly in a power supply line, such as disconnection thereof, which is routed from the power supply circuit to drive circuits cannot be detected. As a result, there is a problem in that it is difficult to prevent anomalous display caused by disconnection or the like of the power supply line, and it is difficult to perform analysis when anomalous display has occurred.

### SUMMARY

One aspect of the present disclosure relates to a display driver including: a power supply circuit that generates a power supply voltage; a drive circuit that drives an electro-optical panel based on the power supply voltage; a control circuit that controls the drive circuit; a power supply line through which the power supply voltage from the power supply circuit is supplied to the drive circuit; a first monitoring circuit that monitors the voltage at a first node, of the power supply line, that is closer to the power supply circuit than to the drive circuit, and outputs the monitoring result to the control circuit; and a second monitoring circuit that monitors the voltage at a second node, of the power supply line, that is closer to the drive circuit than to the power supply circuit, and outputs the monitoring result to the control circuit.

### BRIEF DESCRIPTION OF THE DRAWINGS

The disclosure will be described with reference to the accompanying drawings, wherein like numbers reference like elements.

FIG. 1 is an exemplary configuration of a display driver of a present embodiment.

FIG. 2 is another exemplary configuration of the display driver.

FIG. 3 is a detailed first exemplary configuration of the display driver.

FIG. 4 is a detailed second exemplary configuration of the display driver.

FIG. 5 is an exemplary configuration of a monitoring circuit.

FIG. 6 is an exemplary configuration of a power supply circuit.

FIG. 7 is an exemplary configuration of a scan line drive cell.

FIG. 8 is an exemplary configuration of a data line drive cell.

FIG. 9 is an exemplary placement configuration of the scan line drive cells and monitoring circuits.

FIG. 10 is an exemplary placement configuration of the scan line drive cells and monitoring circuits.

FIG. 11 is an exemplary placement configuration of data line drive cells and monitoring circuits.

FIG. 12 is a detailed exemplary layout arrangement of the display driver.

FIG. 13 is a modification of the display driver of the present embodiment.

FIG. 14 is an exemplary configuration of an electronic apparatus.

FIG. 15 is an exemplary configuration of a mobile body.

### DESCRIPTION OF EXEMPLARY EMBODIMENTS

The following is a detailed description of preferred embodiments of the present disclosure. Note that the embodiments described below are not intended to unduly limit the content of the invention recited in the claims, and all of the configurations described in the embodiments are not necessarily essential as solutions provided by the present disclosure.

1. Display Driver

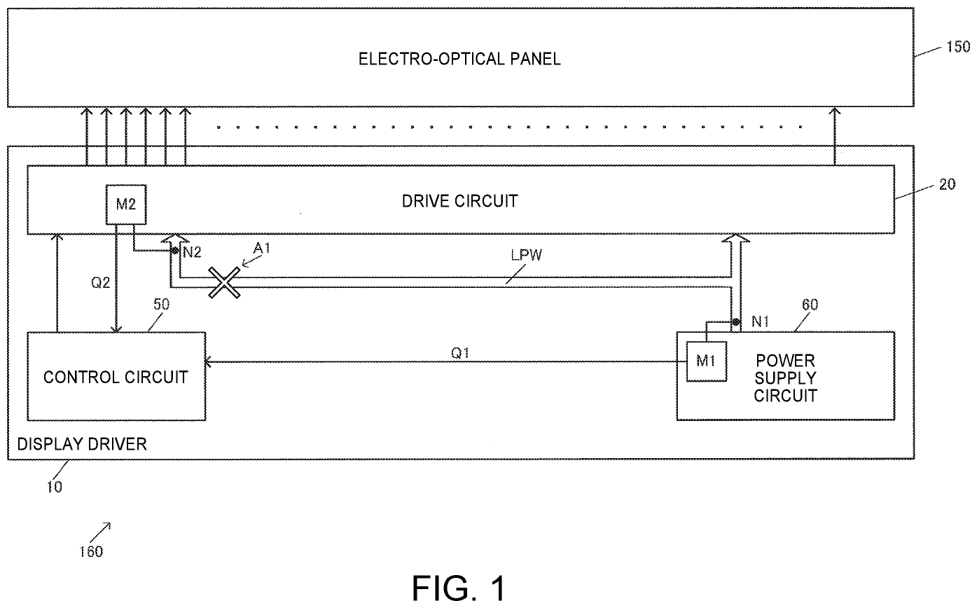

FIG. 1 shows an exemplary configuration of a display driver 10 of a present embodiment. The display driver 10 includes a drive circuit 20, a control circuit 50, a power supply circuit 60, a power supply line LPW, and monitoring circuits M1 and M2. An electro-optical device 160 is constituted by the display driver 10 and an electro-optical panel 150.

The power supply circuit 60 generates a power supply voltage. For example, the power supply circuit 60 generates various power supply voltages needed to drive the electro-optical panel 150. Specifically, the power supply circuit 60 generates a plurality of power supply voltages to be used by the drive circuit 20 by performing a voltage step-up operation and a voltage step-down operation based on a power supply voltage that is input from the outside, and supplies the generated power supply voltages to the drive circuit 20. For example, the power supply circuit 60 generates power supply voltages needed to drive data lines and scan lines of the electro-optical panel 150, and supplies the generated power supply voltages to the drive circuit 20. This power supply circuit 60 can be realized by a DC/DC converter or the like. Specifically, the power supply circuit 60 can be realized by a charge pump circuit that performs a charge pumping operation such as a step-up operation using a charge pump capacitor, or the like.

The power supply line LPW supplies power supply voltages from the power supply circuit 60 to the drive circuit 20. For example, the power supply circuit 60 generates a plurality of power supply voltages and supplies the generated plurality of power supply voltages to the drive circuit 20, and the power supply line LPW includes a plurality of power lines through which the plurality of power supply voltages are supplied. The plurality of power supply voltages generated by the power supply circuit 60 are supplied to the drive circuit 20 through the respective plurality of power lines. That is, the power supply line LPW is a power supply bus through which the plurality of power supply voltages are supplied. The power supply line LPW is realized by an aluminum interconnect layer or the like that is formed on a semiconductor substrate of the display driver 10, which is a semiconductor chip.

The electro-optical panel 150 is a panel for displaying images, and is realized by a liquid-crystal panel, an organic EL panel, or the like. An active matrix type panel that uses a switch element such as a thin film transistor (TFT) can be adopted as the liquid-crystal panel. Specifically, the display panel, which is the electro-optical panel 150, includes a plurality of pixels. For example, the electro-optical panel 150 includes a plurality of pixels that are arranged in a matrix. Also, the electro-optical panel 150 includes a plurality of data lines and a plurality of scan lines that are routed in a direction that intersects the plurality of data lines. The data line is also referred to as a source line, and the scan line is also referred to as a gate line. Also, in the electro-optical panel 150, a plurality of pixels are provided at respective areas where the data lines intersect the scan lines. Also, in a case of an active matrix type panel, a switch element such as a thin film transistor is provided in each pixel region. Also, the electro-optical panel 150 realizes the display operation by changing the optical property of an electro-optical element at each pixel region. The electro-optical element is a liquid crystal element, an EL element, or the like. Note that, in a case of an organic EL panel, a pixel circuit for current-driving an EL element is provided in each pixel region.

The drive circuit 20 drives the electro-optical panel 150 based on the power supply voltages. For example, the drive circuit 20 drives the data lines of the electro-optical panel 150 based on a power supply voltage for driving data lines that is supplied from the power supply circuit 60. For example, the drive circuit 20 drives each data line of the electro-optical panel 150 by outputting a data voltage corresponding to display data to the data line. For example, the drive circuit 20 selects a voltage corresponding to the display data from a plurality of tone voltages supplied from a tone voltage generation circuit, and outputs the selected voltage to the data line as the data voltage. Note that the electro-optical panel 150 may be provided with demultiplexing switch elements, and each amplifier circuit included in the drive circuit 20 may output data voltages corresponding to a plurality of data lines of the electro-optical panel 150 in a time division manner. Also, the drive circuit 20 drives the scan lines of the electro-optical panel 150 based on a power supply voltage for driving scan lines that is supplied from the power supply circuit 60. For example, the drive circuit 20 performs driving for selecting a scan line using a scan line selection voltage corresponding to the power supply voltage for driving scan lines. For example, the drive circuit 20 performs an operation such that the plurality of scan lines are line-sequentially selected.

The control circuit 50 performs various types of control processing such as display control of the electro-optical panel 150, control of circuits in the display driver 10, and interface processing with an external device. The control circuit 50 executes these types of control processing by outputting a plurality of control signals. The control circuit 50 can be realized by a gate array, which is designed using an automatic placement and routing method, or the like.

Also, the control circuit 50 controls the drive circuit 20. For example, the control circuit 50 controls the operation sequence, such as a drive sequence, of the drive circuit 20. For example, the control circuit 50 controls the drive sequence of the data lines of the drive circuit 20, and controls the selection sequence of the scan lines of the drive circuit 20.

The monitoring circuits M1 and M2 are circuits for monitoring the power supply voltages. For example, the monitoring circuits M1 and M2 monitor the power supply voltages by detecting the voltages of the power supply voltages. The monitoring circuit M1 is a first monitoring circuit, and the monitoring circuit M2 is a second monitoring circuit.

Specifically, the monitoring circuit M1, which is a first monitoring circuit, monitors the voltage at a node N1, of the power supply line LPW, that is closer to the power supply circuit 60 than to the drive circuit 20. Also, the monitoring circuit M1 outputs the monitoring result to the control circuit 50. The node N1 is a first node. For example, the monitoring circuit M1 outputs the monitoring result to the control circuit 50 as a detection signal Q1. The node, of the power supply line LPW, that is closer to the power supply circuit 60 than to the drive circuit 20 is a node, on a route of the power supply line LPW, whose distance to the power supply circuit 60 is smaller than that to the drive circuit 20. That is, as shown in FIG. 1, the distance between the node N1 and the power supply circuit 60 is smaller than the distance between the node N1 and the drive circuit 20, on the route of the power supply line LPW.

For example, the monitoring circuit M1 is provided inside the power supply circuit 60. That is, the monitoring circuit M1 is placed in the placement region of the power supply circuit 60. Also, the monitoring circuit M1 performs monitoring operation for detecting power supply voltages at the output node N1, of the power supply circuit 60, to the power supply line LPW. That is, the monitoring circuit M1 monitors the power supply voltages of the power supply line LPW inside the power supply circuit 60.

The monitoring circuit M2, which is a second monitoring circuit, monitors the voltage at a node N2, of the power supply line LPW, that is closer to the drive circuit 20 than to the power supply circuit 60. Also, the monitoring circuit M2 outputs the monitoring result to the control circuit 50. The node N2 is a second node. For example, the monitoring circuit M2 outputs the monitoring result to the control circuit 50 as a detection signal Q2. The node, of the power supply line LPW, on a side closer to the drive circuit 20 than to the power supply circuit 60 is a node, on the route of the power supply line LPW, whose distance to the drive circuit 20 is smaller than that to the supply circuit 60. That is, as shown in FIG. 1, the distance between the node N2 and the drive circuit 20 is smaller than the distance between the node N2 and the power supply circuit 60, on the route of the power supply line LPW.

For example, the monitoring circuit M2 is provided inside the drive circuit 20. That is, the monitoring circuit M2 is placed in the placement region of the drive circuit 20. Also, the monitoring circuit M2 performs monitoring operation for detecting the power supply voltages at the input node N2, of the drive circuit 20, for receiving the power supply line LPW. That is, the monitoring circuit M2 monitors the power supply voltages of the power supply line LPW inside the drive circuit 20. In other words, the monitoring circuit M2 monitors the power supply voltages of the power supply line LPW at a location other than the power supply circuit 60.

In the present embodiment, as described above, the two monitoring circuits M1 and M2 are provided as the circuits for monitoring the power supply voltages of the power supply line LPW. As a result of monitoring the power supply voltages of the power supply line LPW by providing the monitoring circuits M1 and M2 in this way, anomalous display caused by disconnection of the power supply line LPW or the like can be prevented, and the analysis when anomalous display has occurred can be facilitated.

For example, as a method of a comparative example of the present embodiment, a method is conceivable in which the monitoring circuit is provided only on the side of the power supply circuit 60. With this method of the comparative example, when the power supply voltage generated by the power supply circuit 60 is not an appropriate voltage, this fact can be detected and appropriate measures can be taken. Take the display drive device of JP-A-2001-249317 described above as an example, in a period until the power supply voltage reaches a predetermined voltage value, the display of the electro-optical panel 150 is turned off by setting the drive circuit 20 to a stand-by state. With this, the electro-optical panel 150 can be prevented from performing anomalous display due to the power supply voltage not reaching the predetermined voltage value.

However, with the method of the comparative example, when an anomaly such as a disconnection of the power supply line LPW has occurred, as shown by A1 in FIG. 1, this anomaly cannot be detected. Accordingly, for example, if an anomaly such as a disconnection of the power supply line LPW has occurred, even if the power supply circuit 60 generates appropriate power supply voltages, the drive circuit 20 cannot be appropriately supplied with the power supply voltages, and as a result, anomalous display of the electro-optical panel 150 occurs. In particular, when the display driver 10 is installed in an on-board apparatus, high reliability is required, but there is a risk that it is difficult to satisfy this reliability requirement with the method of the comparative example.

In contrast, with the display driver 10 of the present embodiment, when an anomaly occurs such as a disconnection of the power supply line LPW, as shown by A1 in FIG. 1, the occurrence of the anomaly can be detected by the monitoring circuit M2 provided on the drive circuit 20 side monitoring the voltages at the node N2. That is, not only an anomaly on the power supply circuit 60 side, but also an anomaly on the drive circuit 20 side can be detected. Also, the control circuit 50 can be notified of the occurrence of an anomaly using the detection signal Q2, and as a result, anomalous display can be prevented from being performed and the reliability can be improved. Also, when an anomaly has occurred in which the power supply circuit 60 does not generate appropriate power supply voltages, the occurrence of the anomaly can be detected by the monitoring circuit M1 provided on the power supply circuit 60 side monitoring the voltages at the node N1. Also, the control circuit 50 can be notified of the occurrence of an anomaly using the detection signal Q1, and as a result, anomalous display can be prevented from being performed and the reliability can be improved. Accordingly, the display driver 10 can be provided that can be favorably installed in an electronic apparatus such as an on-board apparatus requiring high reliability.

Also, with the display driver 10 of the present embodiment, it is possible to easily analyze, when anomalous display has occurred, whether the anomalous display is an anomaly caused by an inadequate power supply voltage being generated or an anomaly caused by a disconnection or the like of the power supply line LPW. For example, if the detection signal Q1 from the monitoring circuit M1 indicates an anomaly, it can be analyzed that the anomalous display is caused by an inadequate power supply voltage being generated. On the other hand, if the detection signal Q2 from the monitoring circuit M2 indicates an anomaly, it can be analyzed that the anomalous display is caused by a disconnection or the like of the power supply line LPW. Therefore, the analysis to be performed when anomalous display has occurred can be facilitated.

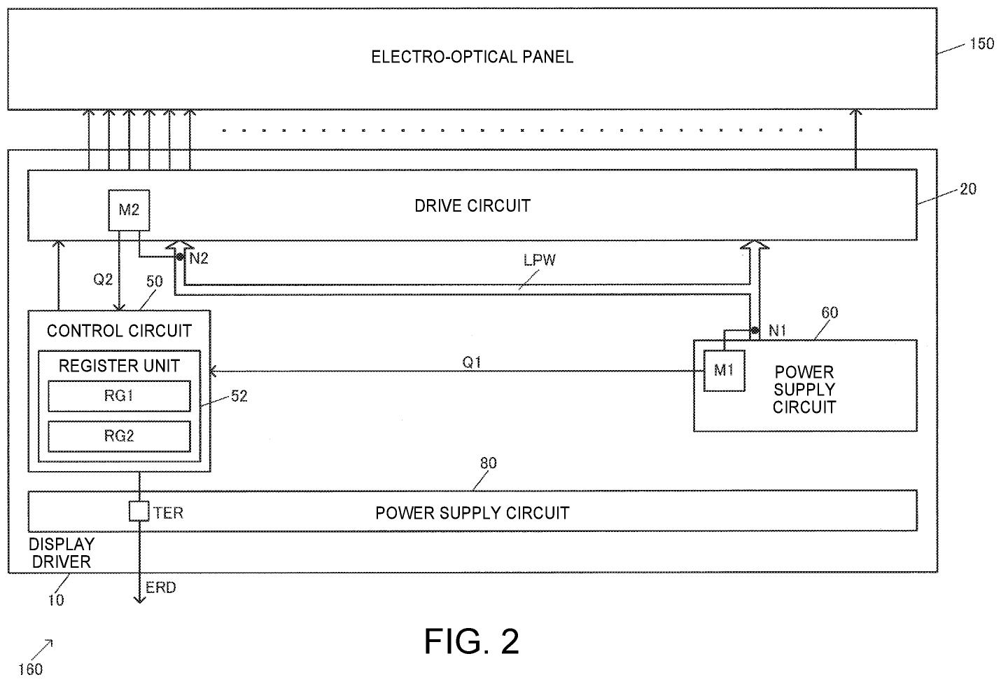

FIG. 2 shows another exemplary configuration of the display driver 10. In FIG. 2, an interface circuit 80 is further provided in addition to the configuration shown in FIG. 1. The interface circuit 80 is an interface circuit between the display driver 10 and an external device. The interface circuit 80 is an I/O circuit of the display driver 10, which is an integrated circuit device, and is provided with a plurality of I/O cells. Each I/O cell is provided with a terminal, which is a pad, an input buffer and an output buffer or an input/output buffer, and a protection circuit such as an electrostatic protection circuit. Also, the control circuit 50 is provided with a register unit 52. For example, the register unit 52 includes registers RG1 and RG2 and the like to which an external device such as a host can access via the interface circuit 80.

The control circuit 50 performs processing for notifying an external device of the error, when one of the monitoring result of the monitoring circuit M1, which is a first monitoring circuit, and the monitoring result of the monitoring circuit M2, which is a second monitoring circuit, indicates that an error has been detected. For example, the control circuit 50 detects an error indicated by the monitoring result of the monitoring circuit M1 based on the detection signal Q1 from the monitoring circuit M1. The control circuit 50 detects power supply error information, for example. Also, the control circuit 50 detects an error indicated by the monitoring result of the monitoring circuit M2 based on the detection signal Q2 from the monitoring circuit M2. The control circuit 50 detects a disconnection of the power supply line LPQ and an anomaly such as an anomaly in a power supply on the drive circuit 20 side, for example. For example, when an error has occurred that is an anomaly in which the power supply circuit 60 does not generate an appropriate power supply voltage, the control circuit 50 is notified of the error using the detection signal Q1. Also, when an error occurs that is an anomaly such as a disconnection or the like of the power supply line LPW, the control circuit 50 is notified of the error using the detection signal Q2. Also, the control circuit 50 performs processing for notifying an external device, such as a host, of an occurrence of this error. In this way, the external device can execute appropriate processing for handling the error that has occurred. For example, the external device such as a host, upon determining that an error has occurred in generating a power supply voltage based on the monitoring result of the monitoring circuit M1, makes instructions for turning off the display of the electro-optical panel 150 and resetting the power supply circuit 60. Also, the external device causes the power supply circuit 60 to again execute a generation sequence of the power supply voltages or the like. Also, the external device such as a host, upon determining that an error has occurred such as a disconnection of the power supply line LPW based on the monitoring result of the monitoring circuit M2, makes instructions for turning off the display of the electro-optical panel 150 and turning off the operations of the power supply circuit 60, for example. Also, the external device can determine that the display driver 10 has failed due to a disconnection or the like of the power supply line LPW. For example, if the monitoring result of the monitoring circuit M2 indicates the occurrence of an error, although the monitoring result of the monitoring circuit M1 does not indicate the occurrence of an error, it can be determined that a failure has occurred in the display driver 10, and detection of failure regarding power supply can be realized.

Also, the display driver 10 of the present embodiment includes a terminal TER for outputting an error detection signal ERD to an external device. For example, the terminal TER is provided in the interface circuit 80, in FIG. 2. For example, the terminal TER is a pad provided in an I/O cell, of the interface circuit 80, for outputting a signal. The error detection signal ERD is output to the external device through the terminal TER. With this, an external device such as a host can determine that the monitoring circuits M1 and M2 have detected an error using the error detection signal ERD output from the terminal TER. The error detection signal ERD may be an interrupt signal output to the external device such as a host. For example, the display driver 10 is provided with a plurality of error detection circuits including the monitoring circuits M1 and M2. If one of the plurality of error detection circuits has detected an error, the external device is notified of the occurrence of an error using the detection signal ERD, which is an interrupt signal, and the external device is caused to perform interrupt processing.

Also, the display driver 10 of the present embodiment includes the register RG1 to which an error detection flag in the monitoring result of the monitoring circuit M1 is set, and the register RG2 to which an error detection flag in the monitoring result of the monitoring circuit M2 is set. The register RG1 is a first register, and the register RG2 is a second register. The registers RG1 and RG2 can be realized by a flip-flop circuit or the like. The registers RG1 and RG2 may also be realized by a semiconductor memory such as a RAM. In FIG. 2, these registers RG1 and RG2 are provided in the register unit 52 of the control circuit 50. For example, when the monitoring circuit M1 has detected an error due to an anomaly in the power supply voltage, the error detection flag of the register RG1 is set to “1”, for example. When the monitoring circuit M2 has detected an error caused by a disconnection or the like, the error detection flag of the register RG2 is set to “1”, for example. Also, the external device can access the registers RG1 and RG2 via the interface circuit 80. Therefore, the external device can determine that the monitoring circuits M1 and M2 have detected an error by reading out the error detection flags of the registers RG1 and RG2. Specifically, when one of the plurality of error detection circuits including the monitoring circuits M1 and M2 has detected an error, the error detection signal ERD is output from the terminal TER, as an interrupt signal to the external device. That is, the error detection signal ERD is activated. When the detection signal ERD is activated in this way, the external device accesses the register unit 52, and analyses the error factor. Then, if the error detection flag of the register RG1 is set to “1”, the external device determines that the monitoring circuit M1 has detected an error. If the error detection flag of the register RG2 is set to “1”, the external device determines that the monitoring circuit M2 has detected an error. With this, the external device can execute appropriate processing for handling the detected error.

2. Detailed Exemplary Configuration

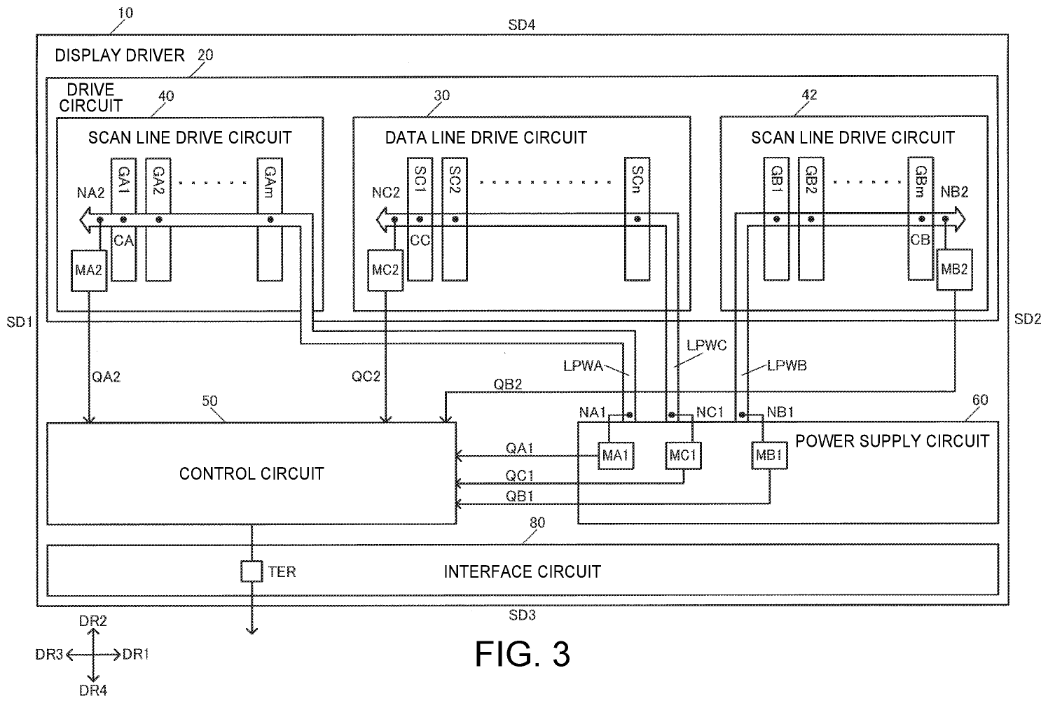

FIG. 3 shows a detailed first exemplary configuration of the display driver 10 of the present embodiment. In FIG. 3, the drive circuit 20 includes a data line drive circuit 30 for driving data lines of the electro-optical panel 150. The data line drive circuit 30 may also be referred to as a source driver. For example, the display driver 10 is provided with a power supply line LPWC through which a power supply voltage for driving data lines is supplied to the data line drive circuit 30 from the power supply circuit 60. The data line drive circuit 30 drives the data lines of the electro-optical panel 150 based on the power supply voltage for driving data lines supplied through the power supply line LPWC. Specifically, the data line drive circuit 30 drives each of the data lines of the electro-optical panel 150 by outputting a data voltage corresponding to display data to the data line. For example, the data line drive circuit 30 selects a voltage corresponding to the display data from a plurality of tone voltages supplied from the tone voltage generation circuit, and outputs the selected voltage to the data line as the data voltage.

The direction from a side SD1 to a side SD2, which are opposing short sides of the display driver 10, is defined as a direction DR1. Also, the direction from a side SD3 to a side SD4, which are opposing long sides of the display driver 10, is defined as a direction DR2. The direction DR2 is a direction orthogonal to the direction DR1. Also, the direction opposite to the direction DR1 is defined as a direction DR3, and the direction opposite to the direction DR2 is defined as a direction DR4. The sides SD1, SD2, SD3, and SD4 are respectively a first side, a second side, a third side, and a fourth side of the display driver 10, and are end sides of a semiconductor chip that realizes the display driver 10. That is, the display driver 10 is realized by an elongated semiconductor chip in which the direction DR1 is a long side direction. Also, the directions DR1, DR2, DR3, and DR4 are respectively a first direction, a second direction, a third direction, and a fourth direction.

The data line drive circuit 30 includes data line drive cells SC1 to SCn that are placed along the direction DR1. The data line drive cells SC1 to SCn are first to n^{th} data line drive cells, n being an integer of two or more. The power supply voltage for driving data lines is supplied to the data line drive cells SC1 to SCn from the power supply circuit 60 through the power supply line LPWC. The data line drive cells SC1 to SCn each include an amplifier circuit that outputs a data voltage. Also, each data line drive cell can include a D/A converter circuit that D/A-converts display data. For example, the D/A converter circuit selects a voltage corresponding to the display data from the plurality of tone voltages from the tone voltage generation circuit, and outputs the selected voltage to the amplifier circuit as the data voltage. The amplifier circuit performs buffering on the data voltage from the D/A converter circuit, and outputs the voltage subjected to the buffering to the data line.

Also, in the present embodiment, the monitoring circuit MC2, which is a second monitoring circuit, is provided at a position corresponding to one data line drive cell of the data line drive cells SC1 and SCn. Here, the data line drive cell SC1 is a first data line drive cell, and the data line drive cell SCn is an n^{th} data line drive cell. In FIG. 3, the aforementioned one data line drive cell is the data line drive cell SC1, and the monitoring circuit MC2 is provided at a position corresponding to the data line drive cell SC1. Being provided at a position corresponding to the data line drive cell SC1 means that the monitoring circuit MC2 is provided at a position close to the data line drive cell SC1, and the monitoring circuit MC2 is provided at a position that is closer to the data line drive cell SC1 than to the data line drive cells SC2 to SCn, for example.

For example, in FIG. 3, the power supply line LPWC is routed through a point at a position on the data line drive cell SCn side as an input point, and is routed in a direction from the data line drive cell SCn toward the data line drive cell SC1. That is, the power supply line LPWC is routed in the direction DR3 from the data line drive cell SCn. In this case, the monitoring circuit MC2 is provided at a position corresponding to the data line drive cell SC1 which is located in an end portion of the power supply line LPWC on the direction DR3 side. In this way, the monitoring circuit MC2 can detect not only an anomaly due to a disconnection or the like of the power supply line LPWC in the vicinity of the data line drive cell SCn, but also an anomaly due to a disconnection or the like of the power supply line LPWC in the vicinity of the data line drive cell SC1.

That is, in FIG. 3, the monitoring circuit MC1, which is a first monitoring circuit, monitors the voltage at a node NC1 closer to the power supply circuit 60 than to the data line drive circuit 30, and outputs the monitoring result to the control circuit 50 as the detection signal QC1. On the other hand, the monitoring circuit MC2, which is a second monitoring circuit, monitors the voltage at the node NC2 closer to the data line drive circuit 30 than to the power supply circuit 60, and outputs the monitoring result to the control circuit 50 as the detection signal QC2. The node NC1 is a first node, and the node NC2 is a second node. For example, in FIG. 3, the data line drive cell SC1, which is the aforementioned one data line drive cell, is a data line drive cell close to the side SD1 of the sides SD1 and SD2 of the display driver 10. In this case, the node NC2 at which the monitoring circuit MC2 monitors the power supply voltage is a node closer to the side SD1 relative to a connection node CC between the power supply line LPWC and the data line drive cell SC1.

Note that, assume that the power supply line LPWC is routed through a point at a position on the data line drive cell SC1 as an input point, and is routed in a direction from the data line drive cell SC1 toward data line drive cell SCn. That is, assume that the power supply line LPWC is routed in the direction DR1 from the data line drive cell SC1. In this case, the monitoring circuit MC2 is provided at a position corresponding to the data line drive cell SCn, which is located in an end portion of the power supply line LPWC on the direction DR1 side. That is, in this case, the data line drive cell SCn is the aforementioned one data line drive cell, and an anomaly due to a disconnection or the like of the power supply line LPWC in the vicinity of the data line drive cell SCn can be detected with the monitoring circuit MC2.

Also, in FIG. 3, the drive circuit 20 includes scan line drive circuits 40 and 42 that drive the scan lines of the electro-optical panel 150. The scan line drive circuits 40 and 42 are also referred to as gate drivers. For example, the display driver 10 is provided with power supply lines LPWA and LPWB through which a power supply voltage for driving scan lines is supplied to the scan line drive circuits 40 and 42 from the power supply circuit 60. The scan line drive circuits 40 and 42 perform driving for selecting a scan line of the electro-optical panel 150 based on the power supply voltage for driving scan lines supplied through the power supply lines LPWA and LPWB. In one example, the scan line drive circuit 40 performs driving for sequentially selecting odd-numbered scan lines of the electro-optical panel 150, for example, and the scan line drive circuit 42 performs driving for sequentially selecting even-numbered scan lines of the electro-optical panel 150, for example. For example, the scan line drive circuit 40 outputs a scan line drive signal to an input terminal provided on the scan line drive circuit 40 side of the electro-optical panel 150. The scan line drive circuit 42 outputs a scan line drive signal to an input terminal provided on the scan line drive circuit 42 side of the electro-optical panel 150. With this, so-called staggering scan line driving can be realized. Note that the two scan line drive circuits 40 and 42 are provided in the display driver 10 in FIG. 3, but a modification in which only one scan line drive circuit is provided can also be implemented.

Also, the scan line drive circuit 40 includes scan line drive cells GA1 to GAm that are placed along the direction DR1, which is the first direction. The scan line drive circuit 42 includes scan line drive cells GB1 to GBm that are placed along the direction DR1. The scan line drive cells GA1 to GAm and the scan line drive cells GB1 to GBm are each first to m^{th} scan line drive cells, m being an integer of two or more. The power supply voltage for driving scan lines is supplied to the scan line drive cells GA1 to GAm from the power supply circuit 60 through the power supply line LPWA. The power supply voltage for driving scan lines is supplied to the scan line drive cells GB1 to GBm from the power supply circuit 60 through the power supply line LPWB. The scan line drive cells GA1 to GAm and GB1 to GBm each include a driver circuit that is supplied with the power supply voltage for driving scan lines and drives a scan line. The driver circuit outputs a high level, which is a voltage level of a high-potential side power supply, when selecting a scan line, and outputs a low level, which is a voltage level of a low-potential side power supply, when unselecting the scan line.

Next, the placement of monitoring circuits for the scan line drive circuits will be described. First, the placement in the scan line drive circuit 40 will be described. In the scan line drive circuit 40, a monitoring circuit MA2, which is a second monitoring circuit, is provided at a position corresponding to one scan line drive cell of the scan line drive cells GA1 and GAm. Here, the scan line drive cell GA1 is a first scan line drive cell, and the scan line drive cell GAm is an m^{th} scan line drive cell. In FIG. 3, the aforementioned one scan line drive cell is the scan line drive cell GA1, and the monitoring circuit MA2 is provided at a position corresponding to the scan line drive cell GA1. Being provided at a position corresponding to the scan line drive cell GA1 means that the monitoring circuit MA2 is provided at a position close to the scan line drive cell GA1, and the monitoring circuit MA2 is provided at a position that is closer to the scan line drive cell GA1 than to the scan line drive cells GA2 to GAm, for example.

For example, in FIG. 3, the power supply line LPWA is routed through a point at a position on the scan line drive cell GAm side as an input point, and is routed in a direction from the scan line drive cell GAm toward the scan line drive cell GA1. That is, the power supply line LPWA is routed in the direction DR3 from the scan line drive cell GAm. In this case, the monitoring circuit MA2 is provided at a position corresponding to the scan line drive cell GA1, which is located in an end portion of the power supply line LPWA on the direction DR3 side. In this way, the monitoring circuit MA2 can detect not only an anomaly due to a disconnection or the like of the power supply line LPWA in the vicinity of the scan line drive cell GAm, but also an anomaly due to a disconnection or the like of the power supply line LPWA in the vicinity of the scan line drive cell GA1.

That is, in FIG. 3, the monitoring circuit MA1, which is a first monitoring circuit, monitors the voltage at a node NA1 closer to the power supply circuit 60 than to the scan line drive circuit 40, and outputs the monitoring result to the control circuit 50 as the detection signal QA1. On the other hand, the monitoring circuit MA2, which is a second monitoring circuit, monitors the voltage at the node NA2 closer to the scan line drive circuit 40 than to the power supply circuit 60, and outputs the monitoring result to the control circuit 50 as the detection signal QA2. The node NA1 is a first node, and the node NA2 is a second node. For example, in FIG. 3, the aforementioned one scan line drive cell GA1 is a scan line drive cell close to the side SD1 of the sides SD1 and SD2 of the display driver 10. In this case, the node NA2 at which the monitoring circuit MA2 monitors the power supply voltage is a node closer to the side SD1 relative to the connection node CA between the scan line drive cell GA1 and the power supply line LPWA.

Next, the placement of cells on the scan line drive circuit 42 will be described. In the scan line drive circuit 42, the monitoring circuit MB2, which is a second monitoring circuit, is provided at a position corresponding to the scan line drive cell GB1 of the scan line drive cells GB1 and GBm. That is, in the scan line drive circuit 40, the aforementioned one scan line drive cell is the scan line drive cell GA1, and the monitoring circuit MA2 is provided at a position of the scan line drive cell GA1. In contrast, in the scan line drive circuit 42, the aforementioned one scan line drive cell is the scan line drive cell GBm, and the monitoring circuit MB2 is provided at a position of the scan line drive cell GBm.

For example, in FIG. 3, the power supply line LPWB is routed through a point at a position on the scan line drive cell GB1 side as an input point, and is routed in a direction from the scan line drive cell GB1 toward the scan line drive cell GBm. That is, the power supply line LPWB is routed in the direction DR1 from the scan line drive cell GB1. In this case, the monitoring circuit MB2 is provided at a position corresponding to the scan line drive cell GBm, which is located in an end portion of the power supply line LPWB on the direction DR1 side. In this way, the monitoring circuit MB2 can detect not only an anomaly due to a disconnection or the like of the power supply line LPWB in the vicinity of the scan line drive cell GB1, but also an anomaly due to a disconnection or the like of the power supply line LPWB in the vicinity of the scan line drive cell GBm.

That is, in FIG. 3, the monitoring circuit MB1, which is a first monitoring circuit, monitors the voltage at a node NB1 closer to the power supply circuit 60 than to the scan line drive circuit 42, and outputs the monitoring result to the control circuit 50 as the detection signal QB1. On the other hand, the monitoring circuit MB2, which is a second monitoring circuit, monitors the voltage at the node NB2 closer to the scan line drive circuit 42 than to the power supply circuit 60, and outputs the monitoring result to the control circuit 50 as the detection signal QB2. The node NB1 is a first node, and the node NB2 is a second node. For example, in FIG. 3, the aforementioned one scan line drive cell GBm is a scan line drive cell close to the side SD2 of the sides SD1 and SD2 of the display driver 10. In this case, the node NB2 at which the monitoring circuit MB2 monitors the power supply voltage is a node closer to the side SD2 relative to the connection node CB between the scan line drive cell GBm and the power supply line LPWB.

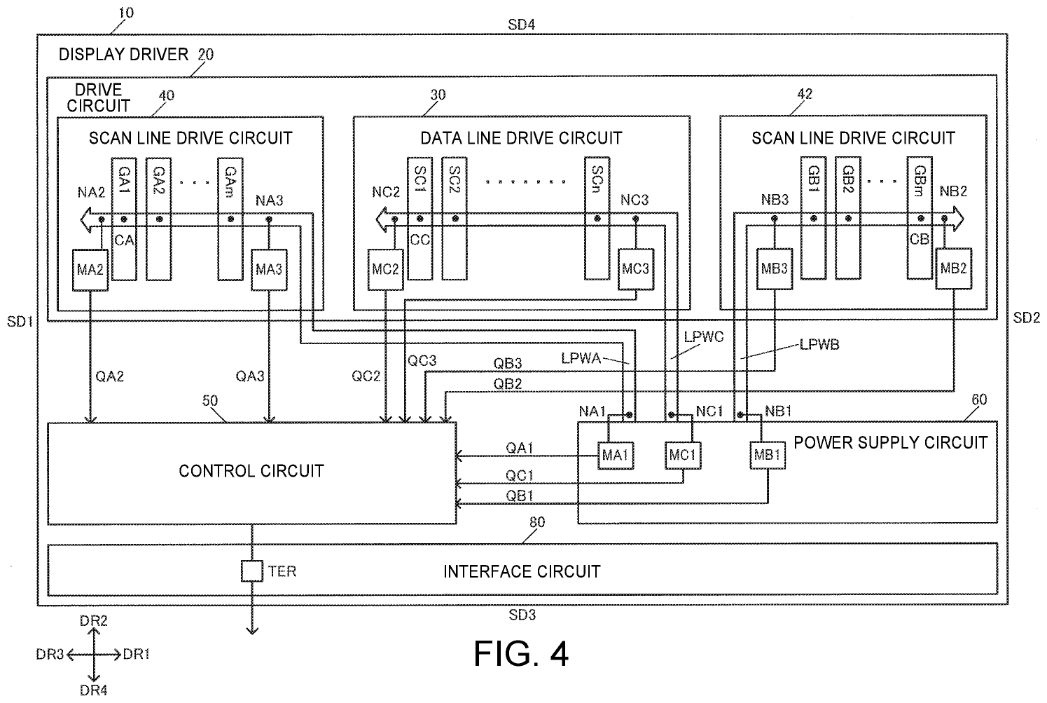

FIG. 4 shows a detailed second exemplary configuration of the display driver 10. In FIG. 4, a monitoring circuit MC3 is provided that monitors the power supply voltage at a node NC3 of the power supply line LPWC, in the data line drive circuit 30. The monitoring circuit MC3 outputs the result of monitoring the power supply voltage at the node NC3 to the control circuit 50 as a detection signal QC3. As described above, in the data line drive circuit 30, the monitoring circuit MC2, which is a second monitoring circuit, is provided at a position corresponding to the data line drive cell SC1, which is one of the data line drive cells SC1 and SCn. Also, the monitoring circuit MC3, which is a third monitoring circuit, is provided at a position corresponding to the data line drive cell SCn, which is the other of the data line drive cells SC1 and SCn. As a result of providing such a monitoring circuit MC3, when an anomaly such as a disconnection of the power supply line LPWC has occurred, it is possible to correctly specify the position at which the anomaly has occurred, and the analysis of the anomalous display can further be facilitated when such an anomaly has occurred. Note that the monitoring circuit MC3 may be provided at an intermediate position between the data line drive cell SC1 and the data line drive cell SCn, for example. That is, the monitoring circuit MC3, which is a third monitoring circuit, needs only be a circuit that monitors the voltage at the node NC3 between the node NC1 and the node NC2 of the power supply line LPWC, and outputs the monitoring result to the control circuit 50.

Also, in FIG. 4, a monitoring circuit MA3 that monitors the power supply voltage at a node NA3 of the power supply line LPWA is provided in the scan line drive circuit 40. The monitoring circuit MA3 outputs the result of monitoring the power supply voltage at the node NA3 to the control circuit 50 as a detection signal QA3. As described above, in the scan line drive circuit 40, the monitoring circuit MA2, which is a second monitoring circuit, is provided at a position corresponding to the scan line drive cell GA1, which is one of the scan line drive cells GA1 and GAm. Also, the monitoring circuit MA3, which is a third monitoring circuit, is provided at a position corresponding to the scan line drive cell GAm, which is the other of the scan line drive cells GA1 and GAm.

Also, a monitoring circuit MB3 that monitors the power supply voltage at a node NB3 of the power supply line LPWB is provided in the scan line drive circuit 42. The monitoring circuit MB3 outputs the result of monitoring the power supply voltage at the node NB3 to the control circuit 50 as a detection signal QB3. As described above, in the scan line drive circuit 42, the monitoring circuit MB2, which is a second monitoring circuit, is provided at a position corresponding to the scan line drive cell GBm, which is one of the scan line drive cells GB1 and GBm. Also, the monitoring circuit MB3, which is a third monitoring circuit, is provided at a position corresponding to the scan line drive cell GB1, which is the other of the scan line drive cells GB1 and GBm. As a result of providing such monitoring circuits MA3 and MB3 described above, when an anomaly such as a disconnection of the power supply lines LPWA and LPWB has occurred, it is possible to correctly specify the position at which the anomaly has occurred, and the analysis of the anomalous display can further be facilitated when such an anomaly has occurred. Note that the monitoring circuit MA3, which is a third monitoring circuit, may be provided at an intermediate position between the scan line drive cell GA1 and the scan line drive cell GAm, for example. Also, the monitoring circuit MB3, which is a third monitoring circuit, may be provided at an intermediate position between the scan line drive cell GB1 and the scan line drive cell GBm, or the like. That is, the monitoring circuit MA3 need only be a circuit that monitors the voltage at the node NA3 between the node NA1 and the node NA2 of the power supply line LPWA, and outputs the monitoring result to the control circuit 50. Also, the monitoring circuit MB3 need only be a circuit that monitors the voltage at the node NB3 between the node NB1 and the node NB2 of the power supply line LPWB, and outputs the monitoring result to the control circuit 50.

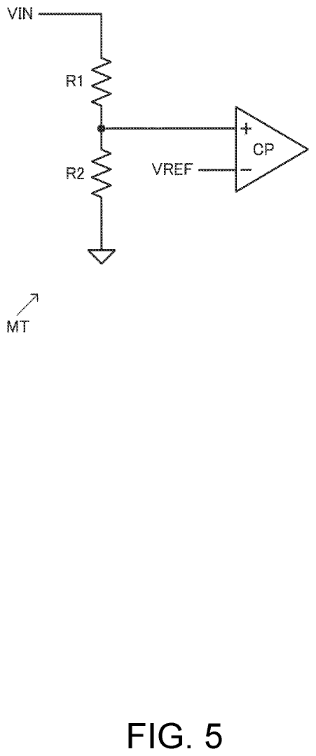

FIG. 5 shows an exemplary configuration of a monitoring circuit MT. The monitoring circuit MT corresponds to the monitoring circuits M1 and M2, MA1 to MA3, MB1 to MB3, and MC1 to MC3 in FIGS. 1 to 4. The monitoring circuit MT in FIG. 5 includes a comparator CP and resistors R1 and R2. The resistors R1 and R2 are provided in series between an input node of a voltage VIN and a VSS node. A voltage division node, which is the connection node of the resistor R1 and the resistor R2, is connected to a non-inverting input terminal, which is a first input terminal, of the comparator CP. A reference voltage VREF is input to an inverting input terminal, which is a second input terminal, of the comparator CP. The voltage VIN is a power supply voltage to be monitored by the monitoring circuit MT. That is, the input node of the voltage VIN corresponds to the nodes N1, N2, NA1 to NA3, NB1 to NB3, and NC1 to NC3 in FIGS. 1 to 4. Also, the output signal of the comparator CP is the detection signals Q1, Q2, QA1 to QA3, QB1 to QB3, and QC1 to QC3. Note that the monitoring circuit MT is not limited to the configuration in FIG. 5, and various modifications such as omitting or changing the constituent elements and adding another constituent element can be implemented. Also, the connection in the present embodiment is an electrical connection. The electrical connection means a connection through which an electrical signal can be transmitted, is a connection through which information can be transmitted by an electrical signal, and may be a connection via a signal line, an active element, or the like.

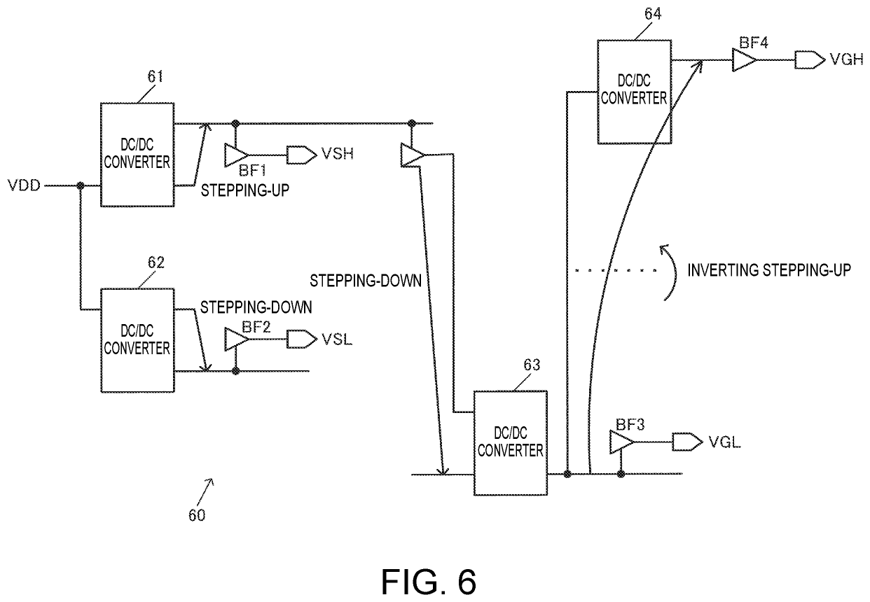

FIG. 6 shows an exemplary configuration of the power supply circuit 60. The power supply circuit 60 includes DC/DC converters 61, 62, 63, and 64, and buffer circuits BF1, BF2, BF3, and BF4. The DC/DC converters 61, 62, 63, and 64 can each be realized by a charge pump circuit that performs charge pumping operation using a capacitor, for example. A voltage VDD, which is an external power supply, is input to the DC/DC converters 61 and 62. Also, the DC/DC converter 61 generates a voltage VSH, which is a high potential side power supply voltage for driving data lines, by performing a step-up operation using the voltage VDD. The DC/DC converter 62 generates a voltage VSL, which is a low potential side power supply voltage for driving data lines, by performing a step-down operation using the voltage VDD. The power supply voltages VSH and VSL are buffered by the buffer circuits BF1 and BF2, and are output to the data line drive circuit 30. The DC/DC converter 63 generates a voltage VGL, which is a low potential side power supply voltage for driving scan lines, by performing a step-down operation using the voltage VSH. The DC/DC converter 64 generates a voltage VGH, which is a high potential side power supply voltage for driving scan lines, by performing an inverting step-up operation using the voltage VGL. The power supply voltages VGL and VGH are buffered by the buffer circuits BF3 and BF4, and are output to the scan line drive circuits 40 and 42. The voltage VSH is 4.65 V to 6.20 V, and the voltage VSL is −4.65 V to −6.20 V, as an example. Also, the voltage VGH is 12.0 V to 17.0 V, the voltage VGL is −14.5 V to −5.0 V, and the counter electrode voltage of the electro-optical panel 150 is −2.5 V to 0.0 V. Note that the power supply circuit 60 is not limited to the configuration in FIG. 6, and various modifications such as omitting or changing the constituent elements and adding another constituent element can be implemented. For example, the power supply voltages may be generated using a method that is different from the charge pump method.

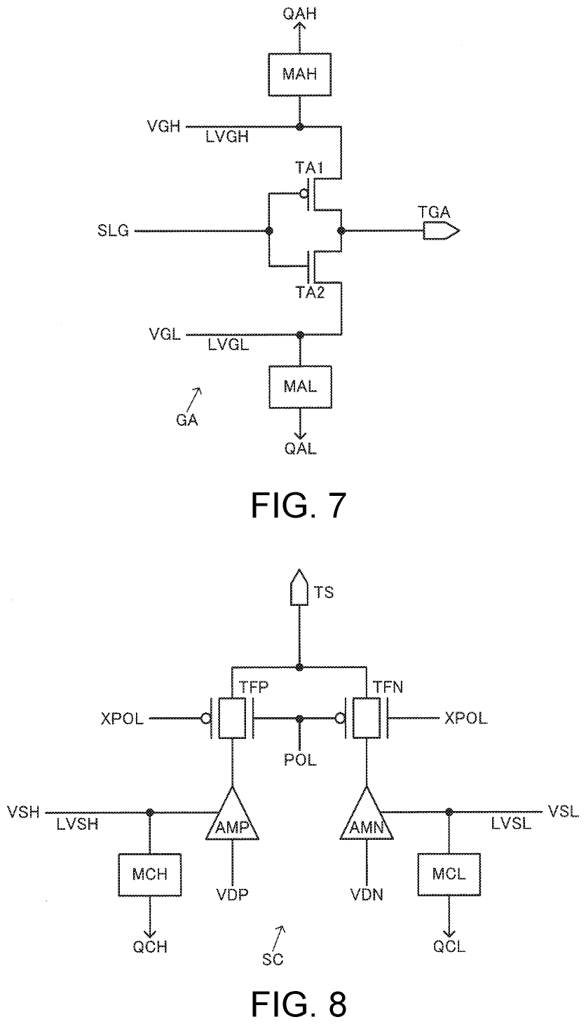

FIG. 7 shows an exemplary configuration of a scan line drive cell GA. The scan line drive cell GA corresponds to the scan line drive cells GA1 to GAm and GB1 to GBm in FIGS. 3 and 4. The scan line drive cell GA includes a buffer circuit constituted by a P-type transistor TA1 and an N-type transistor TA2. A source of the transistor TA1 is supplied with a high potential side power supply voltage VGH for driving scan lines, and a source of the transistor TA2 is supplied with the low potential side power supply voltage VGL for driving scan lines. A scan line selection signal SLG is input to gates of the transistors TA1 and TA2, and a scan line drive voltage is output to an output terminal TGA from the connection node of drains of the transistors TA1 and TA2. The scan line drive voltage of the selected scan line turns to a high level, which is a voltage level of the voltage VGH, and the scan line drive voltage of the unselected scan line turns to a low level, which is a voltage level of the voltage VGL.

Also, a monitoring circuit MAH is connected to a power supply line LVGH, monitors the power supply voltage VGH, and outputs a detection signal QAH. A monitoring circuit MAL is connected to a power supply line LVGL, monitors the power supply voltage VGL, and outputs a detection signal QAL. Note that the scan line drive cell GA is not limited to the configuration in FIG. 7, and various modifications such as omitting or changing the constituent elements and adding another constituent element can be implemented.

FIG. 8 shows an exemplary configuration of a data line drive cell SC. The data line drive cell SC corresponds to the data line drive cells SC1 to SCn in FIGS. 3 and 4. The data line drive cell SC includes amplifier circuits AMP and AMN, and transfer gates TFP and TFN, which are switch elements. The amplifier circuit AMP is an amplifier circuit for positive polarity, and receives an input of a data voltage VDP for positive polarity. The amplifier circuit AMN is an amplifier circuit for negative polarity, and receives a data voltage VDN for negative polarity. The power supply voltage for driving data lines VSH and VSL are respectively supplied to the power supply voltages of the amplifier circuits AMP and AMN. That is, the power supply voltages VSH and VSL are respectively power supply voltages for positive polarity and for negative polarity. The transfer gates TFP and TFN are turned on and off by polarity selection signals POL and XPOL. X means a negative logic. For example, in a positive electrode driving period, the transfer gate TFP is turned on, and the output voltage of the amplifier circuit AMP is output to an output terminal TS as the data voltage. In a negative electrode driving period, the transfer gate TFN is turned on, and the output voltage of the amplifier circuit AMN is output to the output terminal TS, as the data voltage.

Also, a monitoring circuit MCH is connected to a power supply line LVSH, monitors the power supply voltage VSH, and outputs a detection signal QCH. A monitoring circuit MCL is connected to a power supply line LVSL, monitors the power supply voltage VSL, and outputs a detection signal QCL. Note that the data line drive cell SC is not limited to the configuration in FIG. 8, and various modifications such as omitting or changing the constituent elements and adding another constituent element can be implemented.

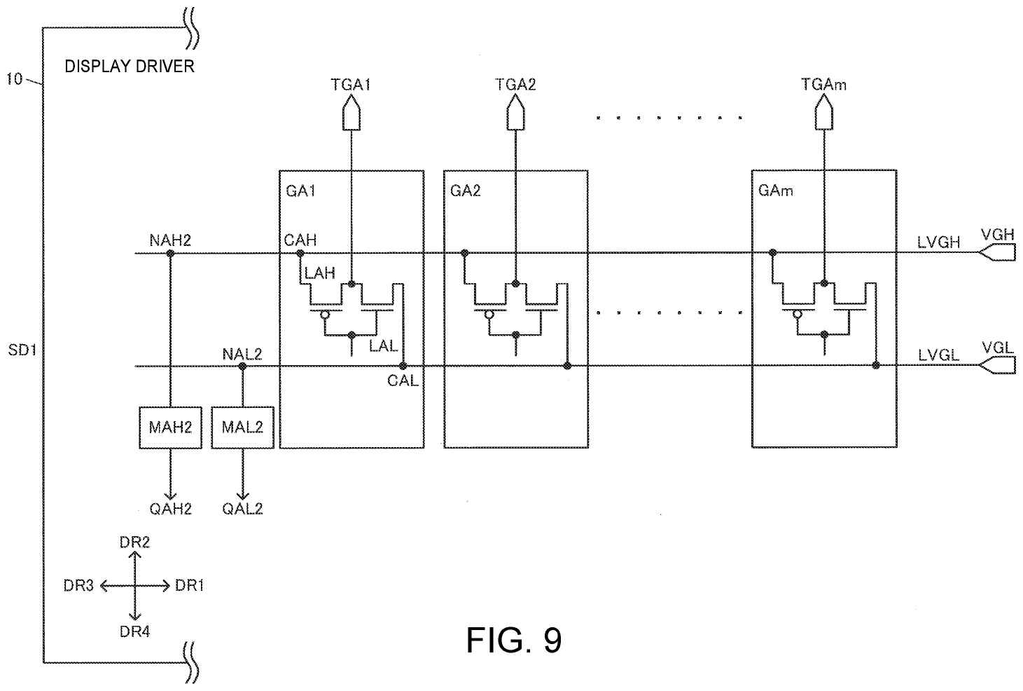

FIG. 9 shows a detailed exemplary placement configuration of the scan line drive cells GA1 to GAm, and monitoring circuits MAH2 and MAL2. The power supply lines LVGH and LVGL respectively supply the power supply voltages VGH and VGL from the power supply circuit 60 to the scan line drive cells GA1 to GAm. The monitoring circuits MAH2 and MAL2 are second monitoring circuits. The monitoring circuit MAH2 monitors the power supply voltage VGH at a node NAH2 of the power supply line LVGH, and outputs a detection signal QAH2. The monitoring circuit MAL2 monitors the power supply voltage VGL at a node NAL2 of the power supply line LVGL, and outputs a detection signal QAL2.

As described above, in the present embodiment, the monitoring circuits MAH2 and MAL2, which are second monitoring circuits, are provided at a position corresponding to the scan line drive cell GA1, which is the one scan line drive cell of the scan line drive cells GA1 and GAm. In FIG. 9, the one scan line drive cell GA1 is a scan line drive cell on a side close to the side SD1, which is one of the sides SD1 and SD2 of the display driver 10. The scan line drive cell GA1 is placed at a position closer to the side SD1 relative to the scan line drive cell GAm.

Also, the one scan line drive cell GA1 includes power lines LAH and LAL and connection nodes CAH and CAL, and the power supply voltages VGH and VGL are supplied through the power lines LAH and LAL that are respectively connected to the power supply lines LVGH and LVGL at the connection nodes CAH and CAL. The connection nodes CAH and CAL are first connection nodes, and correspond to the connection node CA in FIGS. 3 and 4. Also, the power lines LAH and LAL are first power lines. For example, one end of the power line LAH is connected to the power supply line LVGH at the connection node CAH. Also, the other end of the power line LAH is connected to a source of a P-type transistor of a driver circuit of the scan line drive cell GA1. Also, one end of the power line LAL is connected to the power supply line LVGL at the connection node CAL. Also, the other end of the power line LAL is connected to a source of an N-type transistor of the driver circuit of the scan line drive cell GA1.

Also, in FIG. 9, the nodes NAH2 and NAL2, which are second nodes, at which the power supply voltages VGH and VGL are respectively monitored by the monitoring circuits MAH2 and MAL2 are nodes at positions closer to the side SD1, which is one side of the display driver 10, relative to the connection nodes CAH and CAL, which are first connection nodes. That is, the nodes NAH2 and NAL2 at which the monitoring circuits MAH2 and MAL2 are respectively connected to the power supply lines LVGH and LVGL are nodes at positions closer to the side SD1 of the display driver 10 relative to the connection nodes CAH and CAL at which the power lines LAH and LAL of the scan line drive cell GA1 are respectively connected. In this way, when an anomaly such as a disconnection of the power supply line LVGH or LVGL has occurred at a position on the direction DR1 side relative to the connection nodes CAH and CAL as well, the monitoring circuits MAH2 and MAL2 can appropriately detect the anomaly such as a disconnection. For example, with a method in which the power supply voltages VGH and VGL are monitored at a position on the direction DR1 side relative to the connection nodes CAH and CAL, when a disconnection occurs in the vicinity of the scan line drive cell GA1, for example, there may be a case where this disconnection cannot be detected. In this regards, in FIG. 9, since the monitoring circuits MAH2 and MAL2 detects a disconnection or the like by monitoring the power supply voltages VGH and VGL at the nodes NAH2 and NAL2 on the direction DR3 side relative to the connection nodes CAH and CAL, the aforementioned case can be prevented from occurring.

Note that the second nodes at which the monitoring circuits MAH2 and MAL2 monitor the power supply voltages VGH and VGL may be the connection nodes CAH and CAL of the power lines LAH and LAL in the scan line drive cell GA1.

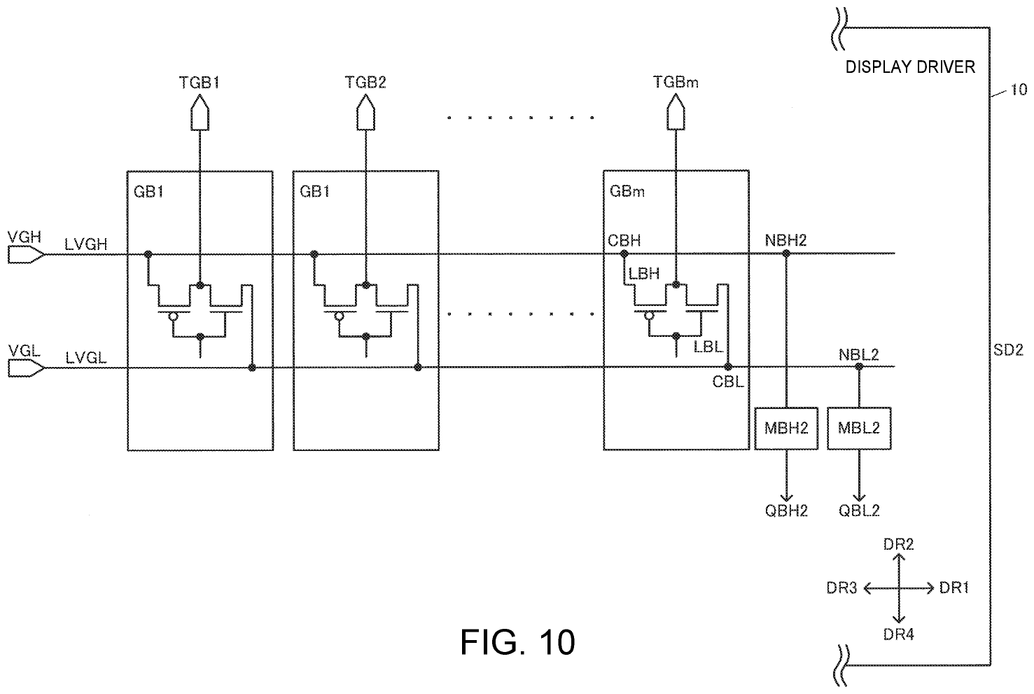

FIG. 10 shows a detailed exemplary placement configuration of the scan line drive cells GB1 to GBm and monitoring circuits MBH2 and MBL2. The power supply lines LVGH and LVGL respectively supply the power supply voltages VGH and VGL from the power supply circuit 60 to the scan line drive cells GB1 to GBm. The monitoring circuits MBH2 and MBL2 are second monitoring circuits. The monitoring circuit MBH2 monitors the power supply voltage VGH at a node NBH2 of the power supply line LVGH, and outputs a detection signal QBH2. The monitoring circuit MBL2 monitors the power supply voltage VGL at a node NBL2 of the power supply line LVGL, and outputs a detection signal QBL2.

Also, in FIG. 10, the monitoring circuits MBH2 and MBL2, which are second monitoring circuits, are provided at positions corresponding to the scan line drive cell GBm, which is the one scan line drive cell of the scan line drive cells GB1 and GBm. The one scan line drive cell GBm is a scan line drive cell close to the side SD2, which is one side of the sides SD1 and SD2 of the display driver 10.

Also, the one scan line drive cell GBm includes power lines LBH and LBL and connection nodes CBH and CBL, and the power supply voltages VGH and VGL are supplied through the power lines LBH and LBL that are respectively connected to the power supply lines LVGH and LVGL at the connection nodes CBH and CBL. The connection nodes CBH and CBL are first connection nodes, and correspond to the connection node CB in FIGS. 3 and 4. Also, the power lines LBH and LBL are first power lines. For example, one end of the power line LBH is connected to the power supply line LVGH at the connection node CBH. Also, the other end of the power line LBH is connected to a source of a P-type transistor of a driver circuit of the scan line drive cell GBm. Also, one end of the power line LBL is connected to the power supply line LVGL at the connection node CBL. Also, the other end of the power line LBL is connected to a source of an N-type transistor of the driver circuit of the scan line drive cell GBm.

Also, in FIG. 10, the nodes NBH2 and NBL2, which are second nodes, at which the power supply voltages VGH and VGL are monitored by the monitoring circuits MBH2 and MBL2 are nodes at positions closer to the side SD2, which is one side of the display driver 10, relative to the connection nodes CBH and CBL, which are first connection nodes. In this way, when an anomaly such as a disconnection of the power supply line LVGH or LVGL has occurred at a position on the direction DR3 side relative to the connection nodes CBH and CBL as well, the monitoring circuits MBH2 and MBL2 can appropriately detect the anomaly such as a disconnection.

Note that the second nodes at which the monitoring circuits MBH2 and MBL2 monitor the power supply voltages VGH and VGL may also be the connection nodes CBH and CBL of the power lines LBH and LBL in the scan line drive cell GBm.

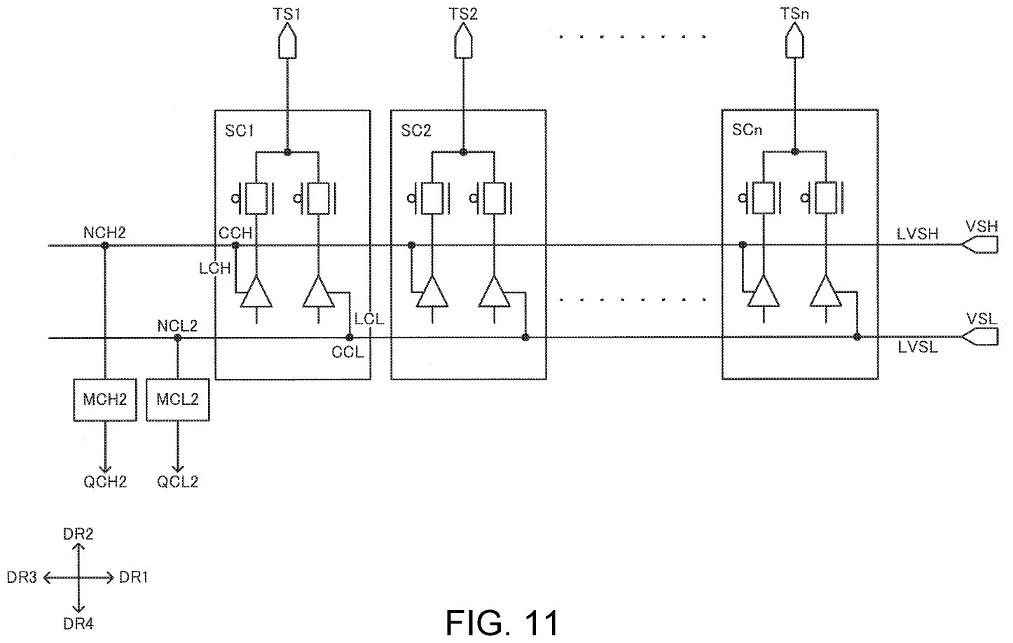

FIG. 11 shows a detailed exemplary placement configuration of the data line drive cells SC1 to SCn and monitoring circuits MCH2 and MCL2. The power supply lines LVSH and LVSL supply the power supply voltages VSH and VSL from the power supply circuit 60 to the data line drive cells SC1 to SCn. The monitoring circuits MCH2 and MCL2 are second monitoring circuits. The monitoring circuit MCH2 monitors the power supply voltage VSH at the node NCH2 of the power supply line LVSH, and outputs a detection signal QCH2. The monitoring circuit MCL2 monitors the power supply voltage VSL at the node NCL2 of the power supply line LVSL, and outputs a detection signal QCL2.

Also, in FIG. 11, the monitoring circuits MCH2 and MCL2, which are second monitoring circuits, are provided at positions corresponding to the data line drive cell SC1, which is the one data line drive cell of the data line drive cells SC1 and SCn. The one data line drive cell SC1 is a data line drive cell close to the side SD1, which is one of the sides SD1 and SD2 of the display driver 10, as shown in FIGS. 3 and 4.

Also, the one data line drive cell SC1 is supplied with the power supply voltages VSH and VSL through power lines LCH and LCL that are connected to the power supply lines LVSH and LVSL at the connection nodes CCH and CCL. The connection nodes CCH and CCL are first connection nodes, and correspond to the connection node CC in FIGS. 3 and 4. Also, the power lines LCH and LCL are first power lines. For example, one end of the power line LCH is connected to the power supply line LVSH at the connection node CCH. Also, the other end of the power line LCH is connected to a power supply terminal of an amplifier circuit for positive polarity in the data line drive cell SC1. With this, the power supply voltage VSH is supplied to the amplifier circuit for positive polarity. Also, one end of the power line LCL is connected to the power supply line LVSL at the connection node CCL. Also, the other end of the power line LCL is connected to a power supply terminal of an amplifier circuit for a negative polarity in the data line drive cell SC1. With this, the power supply voltage VSL is supplied to the amplifier circuit for negative polarity.

Also, in FIG. 11, the nodes NCH2 and NCL2, which are second nodes, at which the power supply voltages VSH and VSL are monitored by the monitoring circuits MCH2 and MCL2, are nodes at positions closer to the side SD1, which is one of the sides of the display driver 10, relative to the connection nodes CCH and CCL, which are first connection nodes. In this way, when an anomaly such as a disconnection of the power supply line LVSH and LVSL has occurred at a position on the direction DR1 side relative to the connection nodes CCH and CCL as well, the monitoring circuits MCH2 and MCL2 can appropriately detect the anomaly such as a disconnection.

Note that the second nodes at which the monitoring circuits MCH2 and MCL2 monitor the power supply voltages VSH and VSL may also be the connection nodes CCH and CCL of the power lines LCH and LCL in the data line drive cell SC1.

3. Exemplary Layout Arrangement and Modifications

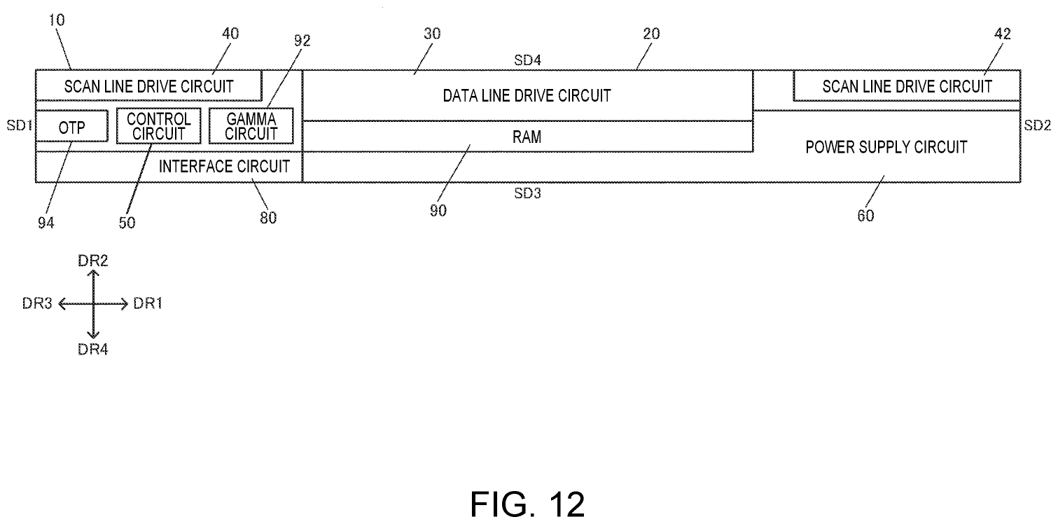

FIG. 12 shows a detailed exemplary layout arrangement of the display driver 10 of the present embodiment. As shown in FIG. 12, the display driver 10 is realized by an elongated semiconductor chip. The display driver 10 has sides SD1 and SD2, which are short sides, and sides SD3 and SD4, which are long sides orthogonal to the sides SD1 and SD2. The sides SD1, SD2, SD3, and SD4 are end sides of a semiconductor substrate of the semiconductor chip, which is the display driver 10. Also, the power supply circuit 60 is provided at a position closer to the side SD3 than to the side SD4. For example, the lower side, which is a long side, of the power supply circuit 60 is a side along the side SD3 of the display driver 10. On the other hand, the drive circuit 20 constituted by the data line drive circuit 30 and the scan line drive circuits 40 and 42 is provided at a position closer to the side SD4 than to the side SD3. For example, the upper side, which is a long side, of the drive circuit 20 is a side along the side SD4 of the display driver 10. Also, the scan line drive circuit 40, the data line drive circuit 30, and the scan line drive circuit 42 are arranged along the direction DR1, which is a direction from the side SD1 toward the side SD2. For example, the data line drive circuit 30 is arranged between the scan line drive circuit 40 and the scan line drive circuit 42. Also, in FIG. 12, when the direction from the side SD4 toward the side SD3 is denoted as a direction DR4, the power supply circuit 60 is provided on the direction DR4 side of the data line drive circuit 30 and the scan line drive circuit 42.

An OTP 94 (One Time Programmable memory), the control circuit 50, and a gamma circuit 92 are provided on the direction DR4 side of the scan line drive circuit 40. The interface circuit 80 is provided on the direction DR4 side of the control circuit 50 and the like. A RAM 90 is provided on the direction DR4 side of the data line drive circuit 30. The OTP 94 is a nonvolatile memory, and stores various types of information such as setting information of the operation sequence of the display driver 10, the display characteristic information of the electro-optical panel 150, and setting information of the power supply voltages of the power supply circuit 60. The control circuit 50 executes various types of control processing of the display driver 10. The gamma circuit 92 is a circuit that generates a plurality of tone voltages to be used by the data line drive circuit 30. The interface circuit 80 is a circuit serving as an interface with an external device, and includes a plurality of I/O cells. The RAM 90 is a memory for storing display data.

As shown in FIG. 12, in the display driver 10 of the present embodiment, the power supply circuit 60 is provided on the side SD3 side, and the drive circuit 20 is provided on the side SD4 side. Therefore, the power supply line LPW having a long routing distance needs to be routed, as shown in FIG. 1 and the like, from the power supply circuit 60 provided on the side SD3 side to the drive circuit 20 provided on the side SD4 side, and as a result, the likelihood that an anomaly such as a disconnection occurs in the power supply line LPW increases. In this regard, in the present embodiment, the monitoring circuit M2 is also provided on the drive circuit 20 side, in addition to the monitoring circuit M1 on the power supply circuit 60. Therefore, even if an anomaly such as a disconnection of the power supply line LPW occurs, as indicated by A1 in FIG. 1, it is possible to detect this anomaly, and notify an external device such as a host of the anomaly.

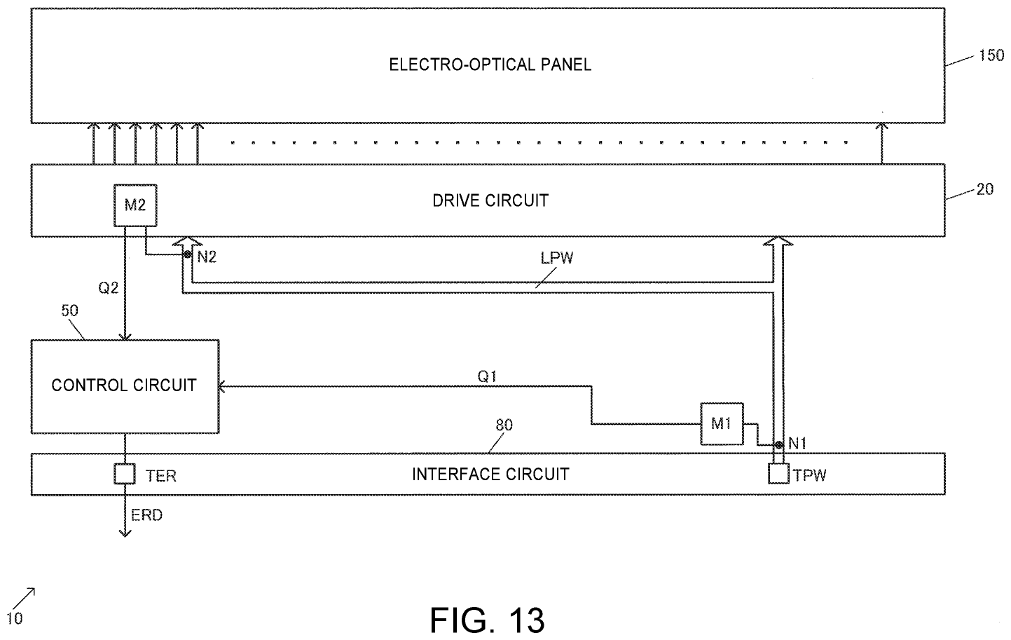

FIG. 13 shows a modification of the display driver 10 of the present embodiment. As shown in FIG. 13, the display driver 10 of the modification includes a power supply terminal TPW to which a power supply voltage is input, a drive circuit 20 that drives an electro-optical panel 150 based on the power supply voltage, a control circuit 50 that controls the drive circuit 20, and a power supply line LPW through which the power supply voltage from the power supply terminal TPW is supplied to the drive circuit 20. The power supply terminal TPW is provided in an interface circuit 80, for example, and a power supply voltage from an external power supply device is supplied to the power supply terminal TPW. Furthermore, the display driver 10 includes a monitoring circuit M2 that monitors the voltage at a node N2, of the power supply line LPW, that is closer to the drive circuit 20 than to the power supply terminal TPW, and outputs the monitoring result to the control circuit 50. The monitoring circuit M2 outputs a detection signal Q2 to the control circuit 50, as the monitoring result. Also, the display driver 10 can include a monitoring circuit M1 that monitors the voltage at a node N1, of the power supply line LPW, that is closer to the power supply terminal TPW than to the drive circuit 20, and outputs the monitoring result to the control circuit 50. The monitoring circuit M1 outputs a detection signal Q1 to the control circuit 50 as the monitoring result. The monitoring circuits M1 and M2 can be respectively referred to as first and second monitoring circuits, and the nodes N1 and N2 can be respectively referred to as first and second nodes.

Although the power supply circuit 60 that supplies power supply voltages to the drive circuit 20 is provided in the display driver 10 in FIGS. 1 and 2, the power supply circuit 60 is not incorporated in the display driver 10 in FIG. 13, and instead is provided with the power supply terminal TPW. Also, a power supply voltage from an external power supply device is supplied to the power supply terminal TPW, and the drive circuit 20 operates based on the power supply voltage supplied through the power supply terminal TPW.

In the modification in FIG. 13, as described above, the monitoring circuit M2 is provided that monitors the voltage at a node N2 closer to the drive circuit 20 than to the power supply terminal TPW. In this way, when an anomaly such as a disconnection of the power supply line LPW has occurred as well, the occurrence of the anomaly can be detected by the monitoring circuit M2 provided on the drive circuit 20 side monitoring the voltage at the node N2. Also, the control circuit 50 can be notified of the occurrence of an anomaly using the detection signal Q2, and as a result, anomalous display can be prevented and the reliability can be improved. Also, when an anomaly has occurred that an appropriate power supply voltage is not supplied through the power supply terminal TPW, the occurrence of the anomaly can be detected by the monitoring circuit M1 provided on the power supply circuit 60 side monitoring the voltage at the node N1. Also, the control circuit 50 can be notified of the occurrence of an anomaly using the detection signal Q1, and as a result, anomalous display can be prevented and the reliability can be improved.

4. Electronic Apparatus and Mobile Body

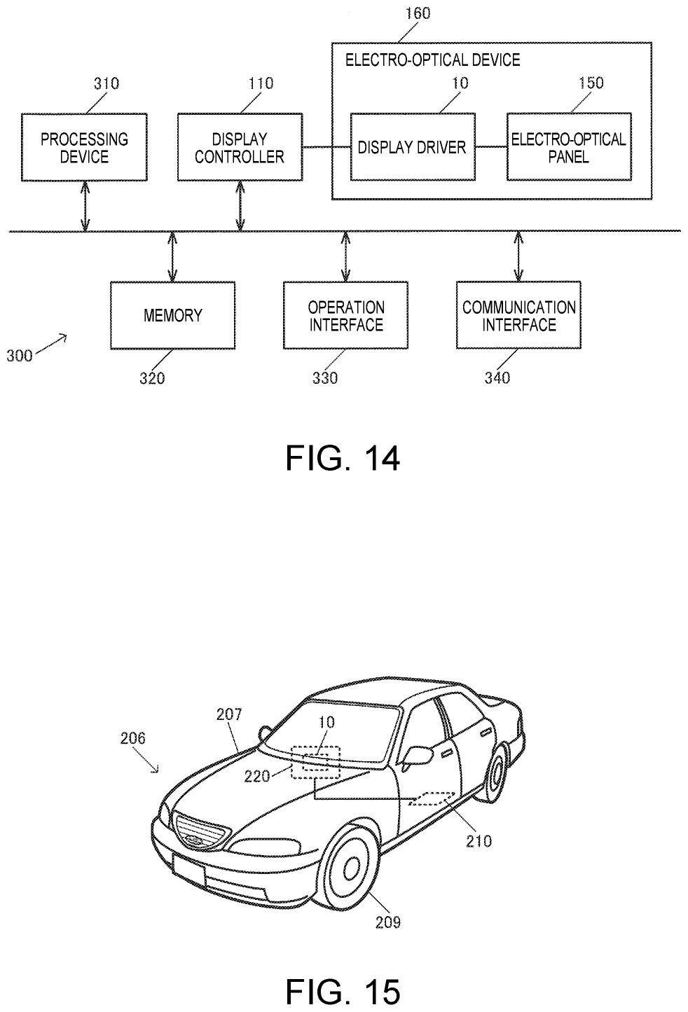

FIG. 14 shows an exemplary configuration of an electronic apparatus 300 including the display driver 10 of the present embodiment. The electronic apparatus 300 includes a display driver 10, an electro-optical panel 150, a display controller 110, a processing device 310, a memory 320, an operation interface 330, and a communication interface 340. An electro-optical device 160 is constituted by the display driver 10, which is a circuit device, and the electro-optical panel 150. Specific examples of the electronic apparatus 300 includes various types of electronic apparatuses, which are a panel apparatus such as a meter panel and a car navigation system, which are on-board apparatuses, a projector, a head mounted display, a printing device, a mobile information terminal, a mobile game terminal, a robot, and an information processing device.

The processing device 310 performs processing for controlling the electronic apparatus 300, various types of signal processing, and the like. The processing device 310 is a host, which is an external device, for example. The processing device 310 can be realized by a processor such as a CPU or an MPU, an ASIC, or the like. The memory 320 stores data from the operation interface 330 and the communication interface 340, and functions as a work memory of the processing device 310, for example. The memory 320 can be realized by a semiconductor memory such as a RAM or ROM, or a magnetic storage device such as a hard disk drive, for example. The operation interface 330 is a user interface for accepting various operations made by a user. For example, the operation interface 330 can be realized by a button, a mouse, and a keyboard, or a touch panel mounted in an electro-optical panel 150. The communication interface 340 is an interface for performing communication of image data and control data. The communication processing of the communication interface 340 may be wired communication processing or wireless communication processing.

FIG. 15 shows an exemplary configuration of a mobile body including the display driver 10 of the present embodiment. The mobile body is an apparatus or device that includes a drive mechanism such as an engine or a motor, a steering mechanism such as a steering wheel or a rudder, and various electronic apparatuses, for example, and moves on the ground, in the air, or on the sea. A car, an airplane, a motorcycle, a ship, a robot, or the like can be envisioned as the mobile body of the present embodiment. FIG. 15 schematically illustrates an automobile 206 serving as a specific example of the mobile body. The automobile 206 includes a car body 207 and wheels 209. A display device 220 including the display driver 10 and a control device 210 that controls the units of the automobile 206 are incorporated in the automobile 206. The control device 210 may include an ECU (Electronic Control Unit) and the like. The display device 220 is realized by the electro-optical device 160, and is a panel apparatus such as a meter panel. The control device 210 generates an image to be displayed to a user, and transmits the image to the display device 220. The display device 220 displays the received image in a display unit of the display device 220. For example, various pieces of information such as a speed, a remaining fuel amount, a travel distance, and various device settings are displayed as images.

As described above, the display driver of the present embodiment includes a power supply circuit that generates a power supply voltage, a drive circuit that drives an electro-optical panel based on the power supply voltage, a control circuit that controls the drive circuit, and a power supply line through which the power supply voltage from the power supply circuit is supplied to the drive circuit. Also, the display driver of the present embodiment includes a first monitoring circuit that monitors a voltage at a first node, of the power supply line, that is closer to the power supply circuit than to the drive circuit, and outputs the monitoring result to the control circuit, and a second monitoring circuit that monitors a voltage at a second node, of the power supply line, that is closer to the drive circuit than to the power supply circuit, and outputs the monitoring result to the control circuit.

According to the present embodiment, the power supply voltage generated by the power supply circuit is supplied to the drive circuit through the power supply line, and the drive circuit drives the electro-optical panel using the supplied power supply voltage. Also, the first monitoring circuit monitors the voltage at the first node, of the power supply line, that is close to the power supply circuit, and outputs the monitoring result to the control circuit, and the second monitoring circuit monitors the voltage at the second node, of the power supply line, that is close to the drive circuit, and outputs the monitoring result to the control circuit. In this way, in addition to an anomaly in the power supply voltage itself generated by the power supply circuit being able to be monitored by the first monitoring circuit, an anomaly such as a disconnection of the power supply line can be monitored by the second monitoring circuit. With this, it is possible to provide a display driver that can prevent anomalous display, and with respect to which analysis when anomalous display has occurred can be facilitated.

Also, in the present embodiment, the drive circuit includes a scan line drive circuit that drives scan lines of the electro-optical panel, and when a direction from a first side to a second side, which are opposing short sides of the display driver, is defined as a first direction, the scan line drive circuit may include first to m^{th} scan line drive cells that are placed along the first direction, m being an integer of two or more. Also, the second monitoring circuit may be provided at a position corresponding to one scan line drive cell of the first scan line drive cell and the m^{th} scan line drive cell.

In this way, not only an anomaly such as a disconnection of the power supply line in the vicinity of another scan line drive cell of the first scan line drive cell and the m^{th} scan line drive cell, but an anomaly such as a disconnection of the power supply line in the vicinity of the one scan line drive cell can be detected by the second monitoring circuit.

Also, in the present embodiment, the one scan line drive cell is a scan line drive cell close to one side of the first and second sides, and the one scan line drive cell includes a first power line and a first connection node, and is supplied with the power supply voltage through the first power line that is connected to the power supply line at the first connection node, and the second node may be a node at a position closer to the one side relative to the first connection node, or the first connection node.

In this way, when an anomaly such as a disconnection of the power supply line occurs at a position closer to the other side relative to the first connection node or at a position of the first connection node as well, the anomaly such as a disconnection can be appropriately detected by the second monitoring circuit.

Also, in the present embodiment, a third monitoring circuit provided at a position corresponding to the other scan line drive cell of the first scan line drive cell and the m^{th} scan line drive cell may be included.

As a result of providing such a third monitoring circuit, when an anomaly such as a disconnection of the power supply line has occurred, it is possible to accurately specify the position at which the anomaly has occurred, and the analysis when anomalous display has occurred can be facilitated.

Also, in the present embodiment, the drive circuit includes a data line drive circuit that drives data lines of an electro-optical panel, and when a direction from a first side to a second side, which are opposing short sides of the display driver, is defined as a first direction, the data line drive circuit includes first to n^{th} data line drive cells that are placed along the first direction, n being an integer of two or more. Also, the second monitoring circuit may be provided at a position corresponding to one data line drive cell of the first data line drive cell and the n^{th} data line drive cell.

In this way, not only an anomaly such as a disconnection of the power supply line in the vicinity of the other data line drive cell of the first data line drive cell and the n^{th} data line drive cell, but an anomaly such as a disconnection of the power supply line in the vicinity of the one data line drive cell can be detected by the second monitoring circuit.

Also, in the present embodiment, the one data line drive cell is a data line drive cell close to one side of the first and second sides, and the one data line drive cell includes a first power line and a first connection node, and is supplied with the power supply voltage through the first power line that is connected to the power supply line at the first connection node, and the second node may be a node at a position closer to the one side relative to the first connection node, or the first connection node.

In this way, when an anomaly such as a disconnection of the power supply line occurs at a position closer to the other side relative to the first connection node or at a position of the first connection node as well, the anomaly such as a disconnection can be appropriately detected by the second monitoring circuit.

Also, in the present embodiment, a third monitoring circuit provided at a position corresponding to the other data line drive cell of the first data line drive cell and the n^{th} data line drive cell may be included.

As a result of providing such a third monitoring circuit, when an anomaly such as a disconnection of the power supply line has occurred, it is possible to accurately specify the position at which the anomaly has occurred, and the analysis when anomalous display has occurred can be facilitated.

Also, in the present embodiment, the display driver has third and fourth sides, which are long sides orthogonal to the first and second sides, and the power supply circuit may be provided at a position closer to the third side than to the fourth side, and the drive circuit may be provided at a position closer to the fourth side than to the third side.

In such an arrangement, although the power supply line having a long routing distance is routed from the power supply circuit provided on the third side to the drive circuit provided on the fourth side, as a result of providing the second monitoring circuit also on the drive circuit side in addition to the first monitoring circuit, an anomaly such as a disconnection of the power supply line can be appropriately detected.

Also, in the present embodiment, a third monitoring circuit may be provided that monitors the voltage at a node between the first node and the second node of the power supply line, and outputs the monitoring result to the control circuit.

As a result of providing such a third monitoring circuit, a monitoring result can be output to the control circuit by monitoring the voltage at a node between the first node and the second node, in addition to the voltages at the first node and the second node, and therefore it is possible to accurately specify the position at which the anomaly has occurred, or the like.

Also, in the present embodiment, when one of the monitoring result of the first monitoring circuit and the monitoring result of the second monitoring circuit indicates that an error has occurred, the control circuit may perform processing for notifying an external device of the error.

In this way, the external device can execute appropriate processing for handling the error that has occurred.

Also, in the present embodiment, a terminal for outputting an error detection signal to an external device may be included.

In this way, the external device can determine whether the first or second monitoring circuit has detected an error using the error detection signal output from the terminal.

Also, in the present embodiment, a first register to which an error detection flag is set depending on the monitoring result of the first monitoring circuit and a second register to which an error detection flag is set depending on the monitoring result of the second monitoring circuit may be included.

In this way, when the first or second monitoring circuit has detected an error, the error factor can be appropriately notified using the error detection flags.

Also, the display driver of the present embodiment includes a power supply terminal to which a power supply voltage is to be input, a drive circuit that drives an electro-optical panel based on the power supply voltage, a control circuit that controls the drive circuit, a power supply line through which the power supply voltage from the power supply terminal is supplied to the drive circuit, and a monitoring circuit that monitors the voltage at a node, of the power supply line, that is closer to the drive circuit than to the power supply terminal, and outputs the monitoring result to the control circuit.

According to the present embodiment, the power supply voltage input through the power supply terminal is supplied to the drive circuit through the power supply line, and the drive circuit drives an electro-optical panel using the supplied power supply voltage. Also, the monitoring circuit monitors the voltage at a node, of the power supply line, that is closer to the drive circuit than to the power supply terminal, and outputs the monitoring result to the control circuit. In this way, when an anomaly such as a disconnection of the power supply line has occurred on the drive circuit side, the monitoring circuit can detect the anomaly, and can notify the control circuit of the anomaly. With this, it is possible to provide a display driver that can prevent anomalous display, and with respect to which analysis when anomalous display has occurred can be facilitated.

Also, the present embodiment relates to an electronic apparatus including the display driver described above.

Also, the present embodiment relates to a mobile body including the display driver described above.

Note that although an embodiment has been described in detail above, a person skilled in the art will readily appreciate that it is possible to implement numerous variations and modifications that do not depart substantially from the novel aspects and effect of the invention. Accordingly, all such variations and modifications are also to be included within the scope of the invention. For example, terms that are used within the description or drawings at least once together with broader terms or alternative synonymous terms can be replaced by those other terms at other locations as well within the description or drawings. Also, all combinations of the embodiment and variations are also encompassed in the range of the invention. Moreover, the configuration and operation of the display driver, the electro-optical device, the electro-optical panel, and the electronic apparatus are not limited to those described in the present embodiment, and various modifications are possible.

What is claimed is:

1. A display driver comprising:
a power supply circuit configured to generate a power supply voltage;
a drive circuit configured to drive an electro-optical panel based on the power supply voltage;
a control circuit configured to control the drive circuit;
a power supply line through which the power supply voltage from the power supply circuit is supplied to the drive circuit;
a first monitoring circuit configured to monitor a voltage at a first node, of the power supply line, that is closer to the power supply circuit than to the drive circuit, and output a monitoring result to a control circuit; and
a second monitoring circuit configured to monitor a voltage at a second node, of the power supply line, that is closer to the drive circuit than to the power supply circuit, and output a monitoring result to the control circuit.

2. The display driver according to claim 1,
wherein the drive circuit includes a scan line drive circuit that drives scan lines of the electro-optical panel,
when a direction from a first side to a second side, which are opposing short sides of the display driver, is defined as a first direction,
the scan line drive circuit includes first to m^{th} scan line drive cells that are placed along the first direction, m being an integer of two or more, and
the second monitoring circuit is provided at a position corresponding to one scan line drive cell of the first scan line drive cell and the m^{th} scan line drive cell.

3. The display driver according to claim 2,
wherein the one scan line drive cell is a scan line drive cell close to one side of the first and second sides,
the one scan line drive cell includes a first power line and a first connection node, and is supplied with the power supply voltage through the first power line that is connected to the power supply line at the first connection node, and
the second node is a node at a position closer to the one side relative to the first connection node, or the first connection node.

4. The display driver according to claim 2, further comprising a third monitoring circuit provided at a position corresponding to another scan line drive cell of the first scan line drive cell and the m^{th} scan line drive cell.

5. The display driver according to claim 1,
wherein the drive circuit includes a data line drive circuit that drives data lines of the electro-optical panel,
when a direction from a first side to a second side, which are opposing short sides of the display driver, is defined as a first direction,
the data line drive circuit includes first to n^{th} data line drive cell that are placed along the first direction, n being an integer of two or more, and
the second monitoring circuit is provided at a position corresponding to one data line drive cell of the first data line drive cell and the n^{th} data line drive cell.

6. The display driver according to claim 5,
wherein the one data line drive cell is a data line drive cell close to one side of the first and second sides,
the one data line drive cell includes a first power line and a first connection node, and is supplied with the power supply voltage through the first power line that is connected to the power supply line at the first connection node, and
the second node is a node at a position closer to the one side relative to the first connection node, or the first connection node.

7. The display driver according to claim 5, further comprising a third monitoring circuit provided at a position corresponding to another data line drive cell of the first data line drive cell and the n^{th} data line drive cell.

8. The display driver according to claim 2,
wherein the display driver has third and fourth sides, which are long sides orthogonal to the first and second sides,
the power supply circuit is provided at a position closer to the third side than to the fourth side, and
the drive circuit is provided at a position closer to the fourth side than to the third side.

9. The display driver according to claim 1, further comprising a third monitoring circuit configured to monitor a voltage at a node between the first node and the second node of the power supply line, and output a monitoring result to the control circuit.

10. The display driver according to claim 1,
wherein the control circuit is configured to, when one of a monitoring result of the first monitoring circuit and a monitoring result of the second monitoring circuit indicates that an error has been detected, perform processing for notifying an external device of the error.

11. The display driver according to claim 10, further comprising a terminal for outputting the error detection signal to the external device.

12. The display driver according to claim 1, further comprising:
a first register to which an error detection flag is set depending on a monitoring result of the first monitoring circuit; and
a second register to which an error detection flag is set depending on a monitoring result of the second monitoring circuit.

13. A display driver comprising:
a power supply terminal to which a power supply voltage is to be input;
a drive circuit configured to drive an electro-optical panel based on the power supply voltage;
a control circuit configured to control the drive circuit;
a power supply line through which the power supply voltage from the power supply terminal is supplied to the drive circuit; and
a monitoring circuit configured to monitor a voltage of a node, of the power supply line, that is closer to the drive circuit than to the power supply terminal, and output a monitoring result to the control circuit.

14. An electronic apparatus comprising:
the display driver according to claim 1.

15. A mobile body comprising:
the display driver according to claim 1.
